(19) United States
(12) Patent Application Publication
(10) Pub. No.: US 2008/0109343 A1
(43) Pub. Date: May 8, 2008

(54) Shared Resource Management

(75) Inventors: David Leslie Robinson, Worcestershire (GB); Graeme James Barclay, Worcestershire (GB); Judith Elizabeth Tyson, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Qinetiq Limited

(21) Appl. No.: 11/661,875

(22) PCT Filed: Sep. 2, 2005
(86) PCT No.: PCT/GB05/03405

§ 371 Date: Mar. 2, 2007

(30) Foreign Application Priority Data
Sep. 8, 2004 (GB) 0419892.5

(51) Int. Cl. G06Q 30/00; G06F 9/50

(52) U.S. Cl. 705/37; 718/103

(57) ABSTRACT

Methods, apparatus, systems, and programs for computers are provided for automatic allocation of resource occupiers (e.g. data, people) to available resources (e.g. bandwidth, radio frequency spectrum, theatre seats). Allocation of resources to resource occupiers is based on a measure of urgency of allocation derived from the size of the resource occupier, the resource available, and the time remaining in which to allocate resource to the resource occupier. One, two, or more time thresholds may be associated with each resource occupier: in particular a timeliness threshold up to which allocation urgency increases but after which it decreases, and a perishability threshold after which allocation of resource to the resource occupier ceases to be at all useful, and after which no more resource is allocated. Also automated auction methods, systems, and programs for real-time allocation of radio frequency spectrum.

### FIELD OF THE INVENTION

The present invention relates to apparatus, methods, signals, and programs for a computer for managing the allocation of limited resources, and systems incorporating the same.

Such resources may include, but are not limited to, computer and communications system resources (e.g. processor time, bandwidth, radio spectrum, etc.). Such resources may also include resources used/occupied by people, including medical/hospital resources such as operating theatres, along with seat allocation for trains, aircraft, or public entertainments, etc., and even accommodation and package holidays.

### BACKGROUND TO THE INVENTION

Management of finite resources is a problem which spans many areas of application.

One particular application of interest is in the management of resources in a computer or communications network. Such resources include bandwidth and server load, and management of such resources has traditionally been done using relatively simple mechanisms such as collision detection, congestion detection, and admission control. Complicated quality-of-service mechanisms also exist which require detailed knowledge of the network and detailed configuration information. In cabled networks, and others in which large bandwidths can be made available, the problem of congestion is sometimes addressed simply by making available more bandwidth. However, in systems in which resources are much more constrained, such as bandwidth in a wireless-based network or any network where bandwidth is limited, of simply providing more resource is not always an option.

Furthermore, even where it is a technically viable option, making more bandwidth available can be expensive and puts pressure on network managers to continue to upgrade networks to stay ahead of demand. Where demand exceeds the network resources available, network collapse follows resulting in the intervention of network engineers and technicians to fix the problem. During times of congestion, neither users' demands nor requested information is prioritised.

In other application areas allocation of resources to resource occupiers is handled in a wide variety of ways. Typically in the case of systems in which people are the resource occupiers (allocation of rooms, beds, seats, etc.), resource allocation may be carried out manually with continual human intervention.

It is known from U.S. Pat. Nos. 6,4987,786 B1 and 6,556,548 B1 to employ Willingness to Pay (WtP) values in resource allocation within communications networks. The paper “A pricing mechanism for Intertemporal Bandwidth Sharing with Random Utilities and Resources” (London School of Economics, Department of Mathematics research report LSE-CDAM-2002-06, 9 Jul. 2002) by Alberto Pompermaier relates to a pricing mechanism for the allocation of bandwidth within telecommunications networks.

A paper entitled “Resource Pricing and the Evolution of Congestions Control” (Automatica 35 (1999), 1969-1985) by R. J. Gibbens and F. P. Kelly describes a method of congestion pricing in networks whereby users are charged for causing congestion.

Regarding known radio spectrum allocation systems, these do not manage resources both fine time and long time dynamically and in an particularly intelligent way. Real user interaction is not included as a fundamental part of the known approaches to allocation in such systems, nor is the ability to charge real money for service, nor the allocation of resources. Known frequency assignment algorithms are complicated and slow. Existing technology in this area is not dynamic, operating instead according to a static configuration and in many cases state-based information needs to be gathered from the resource being managed in order to manage that resource. Furthermore, existing technology does not work at the information or product layer but work instead at the protocol level, down in the mechanics of how the resource is operated.

The invention seeks to provide, inter alia, improved apparatus, methods, signals, and programs for a computer which mitigate one or more problems associated with the prior art.

### SUMMARY OF THE INVENTION

The present inventors have recognised that the utility of allocating resources to resource users varies over time, and after a certain time that utility drops to zero.

The present invention is directed to the management of the resources in a controlled way using a simple economic model, without having to collect voluminous and detailed information about pre-existing resource allocation and utilisation. Resource occupiers/consumers are prioritised and the pattern of resource allocation is controlled according to a measure of the value of allocating resource to resource occupiers/consumers. In the case of computer or communications networks, the approach may be applied at the application layer and may mitigate the problem that applications currently operate blindly assuming the network is still working and uncongested, resulting in application layer collapse and loss of data.

In particular, according to a first aspect of the present invention there is provided an automated method of allocating a plurality of resource occupiers to resources, the method comprising: associating with each resource occupier a timeliness threshold; for each resource occupier calculating a measure of urgency of allocation responsive to the timeliness threshold and a measure of the size of the resource occupier; allocating the resources responsive to the respective measures of urgency of allocation.

Advantageously, resource allocation may be weighted in favour of resource occupiers having greatest need of resources at a given time, whilst avoiding allocation of resources to resource occupiers where their occupation of available resources. would be less profitable, if not unprofitable (e.g. occupation of the resources would fail to satisfy the underlying purpose since the usefulness of such occupation had passed).

The method may also comprise: associating with each resource occupier a perishability threshold; calculating the measure of urgency of allocation responsive to the timeliness threshold, the perishability threshold, and the measure of the size of the resource occupier.

In one preferred embodiment no resource is allocated to a resource occupier whose perishability threshold lies in the past.

Preferably, urgency of allocation is a rising function up to the timeliness threshold, and most preferably a rising convex function.

Preferably, urgency of allocation is a falling function between the timeliness threshold and the perishability threshold, and most preferably a falling convex function.

Preferably, urgency of allocation is zero after the perishability threshold.

In one preferred embodiment the measure of urgency, A, is calculated as:

$$A = \{ \begin{matrix}{P}^{3} arc tan ( \frac{{l}_{t}}{\vert {t}_{j} - t \vert} ) \frac{{( 1 + t )}^{2}}{{( 1 + {t}_{j}^{2} )}^{2}} … 0 \leq t \leq {t}_{j} \\ {P}^{3} arc tan ( \frac{{l}_{t}}{\vert {t}_{j} - t \vert} ) \frac{{( 1 + {t}_{j} )}^{2}}{{( 1 + {t}_{j}^{2} )}^{2}} ( \frac{{( t - {p}_{j} )}^{n}}{{( {t}_{j} - {p}_{j} )}^{n}} ) … {t}_{j} < t \leq {p}_{j} \\ 0 … t > {p}_{j} .\end{matrix}$$

In which:
P is the priority
lₜ is the amount of resource required at a time t
tⱼ is the timeliness threshold (which may be a function of a parameter j)
pⱼ is the perishability threshold
t is the current time
n is a positive number.

The resources may comprise transmission bandwidth, which may in turn comprise radio spectrum bandwidth.

The resources may comprise entities for occupation by people and the resource occupiers comprise people.

The resource occupiers may also comprise vehicles. In this allocation is to be by means of congestion charging.

The resources may comprise Willingness to Pay values. Once allocated these may be used subsequently to allocate actual resource by any known methods.

The invention also provides for resource allocation systems arranged, in operation, to carry out every function of the methods.

In particular there is provided a system for allocating a plurality of resource occupiers to resources, the system comprising: means for associating with each resource occupier a timeliness threshold; means for calculating, for each resource occupier, a measure of urgency of allocation responsive to the timeliness threshold and a measure of the size of the resource occupier; means for allocating the resources responsive to the respective measures of urgency of allocation.

The invention also provides for computer software in a machine-readable form and arranged, in operation, to carry out every function of the apparatus and/or methods.

In particular according to a further aspect of the present invention there is provided a program for a computer for allocating a plurality of resource occupiers to resources, the program comprising code portions arranged for: associating with each resource occupier a timeliness threshold; for each resource occupier calculating a measure of urgency of allocation responsive to the timeliness threshold and a measure of the size of the resource occupier; allocating the resources responsive to the respective measures of urgency of allocation.

The present invention also provides for methods, systems, and programs for computers for automated allocation of radio spectrum.

In particular, according to a further aspect of the present invention there is provided an automated method of allocating radio spectrum between a first set of prospective spectrum users, the method comprising the steps of: conducting an first automated auction between the members of the first set in which the bid price offered by a first member of the first set is determined responsive to a second automated auction held between members of a second set of prospective spectrum users associated with the first member of the first set; allocating spectrum to members of the first set responsive to the first automated auction.

In one preferred embodiment the first auction and second auction are conducted in real time.

In some preferred embodiments resources are allocated to members of the second set according to the method of earlier aspects of the invention described above.

According to a further aspect of the present invention there is provided an automated system for allocating radio spectrum between a first set of prospective spectrum users, the system comprising: means for conducting an first automated auction between the members of the first set in which the bid price offered by a first member of the first set is determined responsive to a second automated auction held between members of a second set of prospective spectrum users associated with the first member of the first set; means for allocating spectrum to members of the first set responsive to the first automated auction.

According to a further aspect of the present invention there is provided a program for a computer for allocating radio spectrum between a first set of prospective spectrum users, the program comprising code portions arranged for: conducting an first automated auction between the members of the first set in which the bid price offered by a first member of the first set is determined responsive to a second automated auction held between members of a second set of prospective spectrum users associated with the first member of the first set; allocating spectrum to members of the first set responsive to the first automated auction.

The preferred features may be combined as appropriate, as would be apparent to a skilled person, and may be combined with any of the aspects of the invention. Other advantages of the invention, beyond the examples indicated above, will also be apparent to the person skilled in the art.

### BRIEF DESCRIPTION OF THE DRAWINGS

In order to show how the invention may be carried into effect, embodiments of the invention are now described below by way of example only and with reference to the accompanying figures in which:

FIG. 1 shows a schematic diagram of a first communications system in accordance with the present invention;

FIG. 2(a) shows a schematic graph of a utility function in accordance with the represent invention;

FIG. 2(b) shows a schematic graph of an importance of allocation function in accordance with the represent invention;

FIG. 3 shows a schematic graph comparing resource allocation in accordance with the present invention with prior art allocation;

FIGS. 4(a) and 4(b) show schematic graphs how the relative proportions of traffic of different priorities may vary over time, and how bandwidth may be correspondingly allocated in accordance with the present invention;

FIG. 5(a) shows a schematic graph of bandwidth allocation in accordance with the prior art;

FIG. 5(b) shows a schematic graph of bandwidth allocation in accordance with the present invention;

FIG. 6 shows a schematic diagram of a second communications system in accordance with the present invention;

FIG. 7 shows a schematic diagram of a first method in accordance with the present invention;

FIG. 8 shows a schematic diagram of a second method in accordance with the present invention;

FIG. 9(a) shows a first example of resource allocation in accordance with the present invention;

FIG. 9(b) shows a second example of resource allocation in accordance with the present invention;

FIG. 10 show a further method in accordance with the present invention;

FIG. 11 shows a still further system in accordance with the present invention

### DETAILED DESCRIPTION OF INVENTION

A first embodiment of this invention is applied to the management of user demand on a bandwidth-limited communications network.

As will be apparent to the person skilled in the art, the scope of the solution described above is much wider than its application to communication systems and can be applied to many other analogous problems.

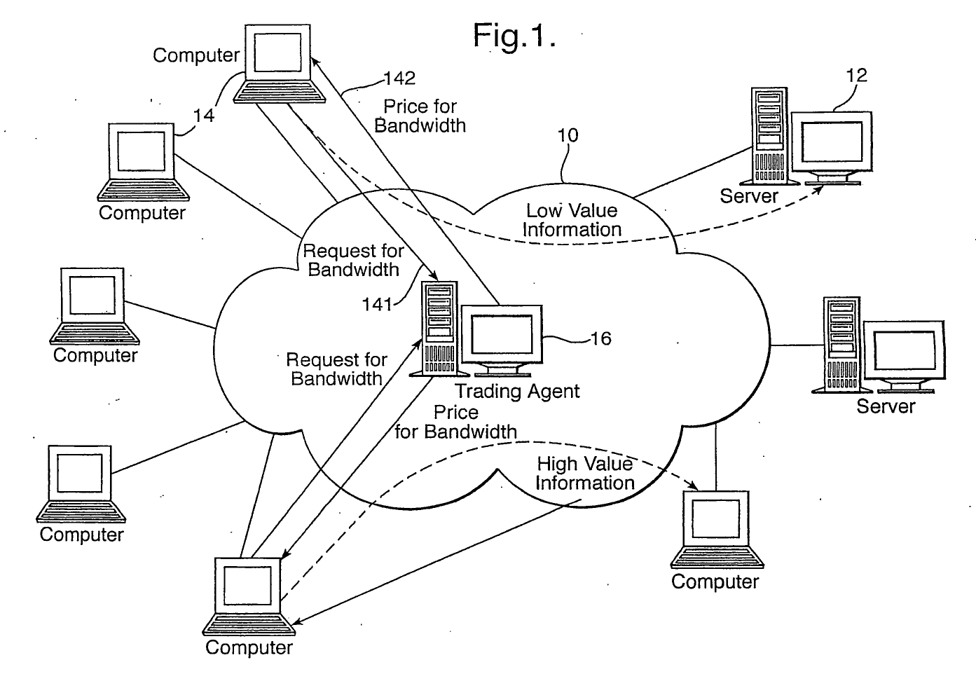

Referring to FIG. 1, a computer network 10 may be treated as a cloud of resource that can be used to transfer information. This resource could be a server's 12 capacity to serve a number of users 14. Here the resource is considered to be bandwidth. Users are allocated money and an income to buy bandwidth to transmit information. Users also have a utility function that they use to determine whether to buy bandwidth and, if so, at what rate and when. A network agent 16 calculates a price for bandwidth according to demand at any time. For a user to buy bandwidth, the user must declare 141 its bandwidth need to the agent, who in turn responds 142 with a price. The user can then decide whether to buy at this price, how much to buy at this price or wait and save money. This can be repeated over a number of cycles causing the users to effectively take part in an auction. To save demand placed on a real user, one approach is to have a local software agent (typically within the network) act on behalf of the user in negotiating prices and bidding for bandwidth. This is known as internal pricing. There are applications however, where the real (e.g. human) users may be more directly involved, via a user interface, and the money involved may be real money. This kind of solution is known as external pricing.

There are a number of contexts in which this method may be applied:
A spot market approach which allows users to take part in an auction over a small period of time to buy bandwidth within the immediate timeliness needs of the applications/processes involved.
A future market approach where users again take part in an auction but declare bandwidth needs ahead of time.
The Gibbens & Kelly congestion pricing approach where users are charged for causing congestion.

These contexts may of course be combined into a single context and it is proposed here to combine the spot market and future market models with a congestion pricing model such as that of Gibbens & Kelly. The spot market and future market act as a feed-forward scheduling solution based on an initial assumption that there is a certain amount of resource (in this case bandwidth) available. The congestion pricing approach adds a feed-back mechanism to correct errors in the original assumption and acts as a method of taking into account the detail of what is actually happening within the network cloud.

By treating the network as a bandwidth cloud the need to maintain timely state information to be able to manage the utilisation of the resource (i.e. bandwidth) is removed. For example there are known control theory approaches that may be applied in which the load at various points throughout the network is measured and used to control user transmission. This approach is likely to lead to instability because load measurements are averaged and also because it takes time to collect those measurements. That kind of solution is also complex. By working at a more abstract level (in the case of computer or communications networks at the application layer) as in the present arrangement, not only is much complexity removed but a mechanism is provided to rate adapt the applications according to network demand, providing end to end traffic management all the way up to the application layer, and including the users' behaviour.

Other benefits of a trading mechanism are a gain in the efficient use of a limited resource by having a scheduling mechanism and a mechanism that avoids boom/bust saturation. Also the resource share that users can have is controlled by the money allocated. Finally, information can be managed end-to-end according to its value to the business or operation. In this way, during times of congestion when the efficiency gains are not enough to compensate, services providing low information value will begin to shut down. Services providing high information value will persist. The result is that core services will be prioritised and guaranteed over peripheral services. The management of the services being effected in detail in accordance with the information they provide. The key features offered by this solution are therefore:
User demand management;
Efficiency gain;
Information management;
Rate and admission control at the application layer;
End to end traffic management;
No need to know detail about the state or structure of the supporting communications;
All users in the system have to register with the trading agent.

In other resource-constrained systems these have equivalents: user demand management may correspond to customer demand management; information management may correspond to the management of a service or product to the customer. Rate and admission control at the application layer effectively means that management of the system is conducted at a high over-arching level. End-to-end traffic management may be viewed as end-to-end service supply. Finally there is no need for any detailed knowledge of the system's internal mechanism for the proposed trading solution to work.

Users are considered to have a need to transfer information and transferring information is deemed to have a value to the user. A function of the cost of paying for the bandwidth needed to transfer information that has a value to the user forms the user's utility in proceeding to use the bandwidth. If the cost balanced with the information value is prohibitively high, and therefore the user's utility low, the user can decide to transmit the information at a lower rate or not at all. Some information will have no value below a threshold rate of transmission and so there would be no utility to the user in reducing the bandwidth below such a threshold. Also, the value of the information may reduce with reducing rate of transmission and so there may be an optimum price for bandwidth balanced with the information value that maximises the utility to the user for transmitting the information at a given rate. Finally, the information value is likely in many cases to reduce with increasing time and so this also features in the utility function and influences the optimum time, rate, and price chosen.

To avoid placing unnecessary demand on the user, the model includes the idea that a user interface acts on behalf of the user in making the decision when to buy bandwidth to carry information. In this way the behaviour of a user in using the limited resource can be controlled by the software which implements the user interface and trading mechanism. The building blocks of this resource trading model are therefore:
Money—A representation of the total resource available to be bought. The total amount of money does not exceed the corresponding total resource available;
Bandwidth—A resource provided by the communications network. The detail of how this is done is not relevant to the model.
Information Value—A value associated with the information content, the amount of information, the timeliness of delivery, the importance to the business of operation etc.
Utility—The balance of cost and information value indicating the value for money that the user obtains.
User interface—Software which makes decisions on behalf of the users about when to buy bandwidth to transfer information.
Network Trading Agent (NTA)—A server whose function is to calculate prices for bandwidth use, taking into account user demand and bandwidth supply. All users joining the network register with the server and pay (the server) to use bandwidth.

There are two versions of the above model: a first in which resource requirements are declared well ahead of time, and a second in which resource requirements are declared as they are needed.

The first version allows the user to declare a need ahead of time, such as booking a video conferencing session. Here the components of the model are applied using an auctioning algorithm and user demand is scheduled. This approach is the future market model and requires more interaction with the user.

The second version is the spot market model, where an auctioning algorithm is applied within a much shorter time-scale such that, for example, if an email is delayed for 5 minutes the user would not be concerned or it would be acceptable for a web page to take up to 5 seconds to load. In the spot market model the real user is unaware that a trading mechanism is active since an agent acts on behalf of the user in the auctioning process. Finally the above approaches may be combined with a congestion pricing approach (such as that of Gibbens & Kelly) whereby users are charged by the network for causing congestion. In this way the network can assert feedback congestion control to fine-tune the ahead-of-time scheduling solutions generated by the auctioning algorithms.

There are two aspects to the supporting architecture for the resource trading model, as shown in FIG. 1. To trade bandwidth a server is provided which acts as an agent whose role is to price and sell bandwidth. The value of information is known by each user's interface. To be able to charge for congestion the network has to generate congestion notifications at any point where congestion happens. This could be implemented within the network, for example, at router interfaces. The supporting architecture is therefore minimal requiring little detailed information about the state of the network in support of the bandwidth cloud.

Transmitted data can be thought of as being one of two types: elastic or inelastic. Elastic traffic, such as e-mail or file transfer, can be transmitted with dynamic control, at any rate; the rate can be increased and decreased according to the available bandwidth. Inelastic traffic, such as voice or video, requires a fixed bandwidth thus any rate adjustment must be done in quantised steps—the amount of bandwidth needed is dependent upon the required quality of the call.

The following discussion on trading concentrates primarily on elastic traffic which allows more flexibility. However, the approach also works for inelastic traffic.

Modelling human-type behaviour is never an easy task but within the literature on economics the concept of choice and an individual's satisfaction is frequently modelled using utility functions. These functions represent an individual's preference over a set of alternatives. It is, in some regard, a measure of satisfaction. However, it is worth noting that in general it is very unlikely that these functions will be known precisely. They merely clarify our thinking and help to build up a simplified picture of how users may act. Such models are not attempts to describe reality; they are attempts to set up a simplified situation with the same logical structure as the more complicated genuine situation.

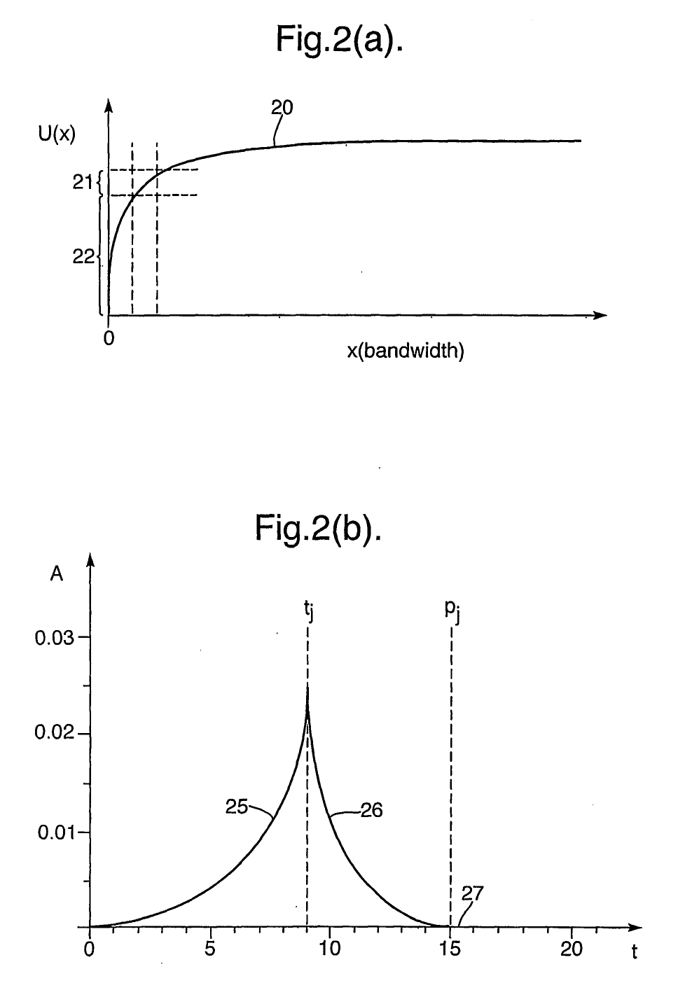

Referring now to FIG. 2(a) a typical example of a utility function, which can be been used in the trading solution, is shown. The graph shows the utility value, U(x), that a resource user receives as a result of being allocated a certain amount of a resource, which in this example is bandwidth. The utility function illustrated is typical of that for elastic traffic; if inelastic traffic were to be catered for then the corresponding utility function would have a similar form but would have quantised steps in it rather than a smooth curve. In general, the more bandwidth the user is allocated the more satisfied the user is, since the user then has the resources to transmit data more quickly and subsequently experience less delay. Utility curves 20 are typically such that the additional utility 21 that a user gains from receiving an extra unit of resource is positive but is less than the marginal utility 22 gained by receiving any previous extra unit of resource. In the example illustrated the user receives greatest increase in utility for the first few units of bandwidth; a user who has already been allocated many units of bandwidth receives only a smaller amount of extra utility by being allocated a further unit of bandwidth. Many utility functions are logarithmic in form, such as ln(1+x), which results in a concave shaped function conveniently giving a utility value of zero when the individual has no units of a resource.

The general form of the utility function used within the following trading models is:

A ln(1+x)+ln(1+M−x) (1)

in which A is a parameter which indicates the importance (or value) of resource occupation (bandwidth utilisation) to the user: the higher the value of A, the higher the importance. The second term introduces the utility of money: M is the amount of money held by a user and c is the cost per unit of bandwidth. Hence (M−cx) gives the amount of money held by a user who also holds x units of bandwidth. The utility of money has the same form as the utility for any other product—individuals who have little money gain more utility from receiving one extra unit of money than those individuals who already have a lot of money would receive from one extra unit.

The parameter A represents the importance of bandwidth occupancy to the individual: users with important information to transfer will be able purchase more bandwidth. The value of bandwidth occupancy could be manually determined by the user. However in a preferred embodiment the importance of bandwidth occupancy is based, not on the information itself, but on the parameters that describe the length of transmission remaining, priority, and timeliness issues as explained below.

Priority—This gives an indication of the criticality of the resource occupier (in this case information) to the user. This can be represented as a simple measure between, for example, 1 and 3 where 1 is routine information and 3 is urgent information. Whilst many priority schemes are based on linearly spaced units other distributions, for example logarithmic, may be employed. An appropriate scale for a given application may be determined empirically.

Timeliness threshold—This is a measure of the time by which the resource (bandwidth) should be allocated to the resource occupier (information). Timeliness of information should not be confused with simple priority: information of low priority might have a short timeliness period whilst information of high priority might not be needed within a short time-scale.

Perishability threshold—This is a measure of the time after which allocating resource (bandwidth) to resource occupiers (information) ceases to have value to the requesting user.

Size of resource occupier—This is a measure of the size of the resource occupier (e.g. information length in terms of bits) not already allocated resource. The size (bits) of the resource occupier (information) is important since the requesting user requires sufficient resource (bandwidth) to be allocated to cater for the whole resource occupier before the timeliness threshold is reached. Consequently if, as the timeliness threshold is approached, the size of resource occupier (bits) remaining to be allocated resource (bandwidth) is still relatively large, then it is important that more resource (bandwidth) be allocated to the resource occupier (information). This increases the likelihood that, overall, sufficient resources are allocated to the resource occupier to ensure that the required task (information transfer over a transmission medium) is achieved.

The form of parameter A—the importance of allocating resource—may be rather complicated. The dominant parameters are Priority and the Timeliness threshold and the characteristics of the function change dependent on whether the current time is less than the timeliness threshold, between the timeliness threshold and the perishability threshold, or greater than the perishability threshold.

In general, and referring now to FIG. 2(b), the importance of allocating resource increases 25 as the timeliness threshold, tⱼ, is approached, decreases 26 between the timeliness threshold and the perishability threshold, pⱼ, and ideally drops to zero 27 after the perishability threshold is passed. The curve is preferably convex up to the timeliness threshold, and preferably convex between timeliness threshold and perishability threshold, but the precise curvature may vary according to the specific application area and may again be established by empirical or other means.

By way of one specific example, A may be defined for a communication bandwidth allocation application by:

$$A = \{ \begin{matrix}{P}^{3} arc tan ( \frac{{l}_{t}}{\vert {t}_{j} - t \vert} ) \frac{{( 1 + t )}^{2}}{{( 1 + {t}_{j}^{2} )}^{2}} … 0 \leq t \leq {t}_{j} \\ {P}^{3} arc tan ( \frac{{l}_{t}}{\vert {t}_{j} - t \vert} ) \frac{{( 1 + {t}_{j} )}^{2}}{{( 1 + {t}_{j}^{2} )}^{2}} ( \frac{{( t - {p}_{j} )}^{n}}{{( {t}_{j} - {p}_{j} )}^{n}} ) … {t}_{j} < t \leq {p}_{j} \\ 0 … t > {p}_{j} .\end{matrix} \qquad ( 2 )$$

In which:
P is the priority
lₜ is the amount of data still to be transmitted at time t
tⱼ is the timeliness threshold pⱼ is the perishability threshold
t is the current time
n is a positive number (which may be a function of parameter j)

In the example schematically illustrated in FIG. 2(b), the timeliness threshold, tⱼ, is set to 9 whilst the perishability threshold, pⱼ, is set to 15.

Clearly the importance of allocating resource, A, increases as the priority increases; the importance of allocating resource increases as the timeliness threshold, tⱼ, is approached; and it also increases if there is a large amount, lₜ, of data to be transmitted in a short remaining time. The perishability threshold, pⱼ, becomes significant after the timeliness threshold has passed and A decreases as time gets closer to the perishability threshold.

The parameter n allows for tuning and is chosen in this example such that priority and timeliness dominate over perishability and remaining data to be transmitted. Values in the range from 1 to 100 have been investigated. For bandwidth trading embodiments, values in the order of 60 were found to give better results.

By calculating the importance of timely allocation of resource, users can assign an importance to their resource allocation (in this example information transfer). Users will also be aware of the quantity of money they have remaining. Thus, when the trading algorithm offers a price for bandwidth, users may request bandwidth that will optimise their utility. The requisite bandwidth requirement can be derived from formula (1) as:

$$x = \frac{A + AM - c}{c ( 1 + A )} \qquad ( 3 )$$

in which c is the cost of one unit of bandwidth.

The trading algorithm can then be used to recalculate current demand for resource allocation and to offer a new price for bandwidth depending on whether there is over-demand for resources (the network is currently congested) or under-demand for resources (the network is uncongested).

This trading method can be applied ahead of time by means of an auction. Such a solution works for both a spot (short-term) market and a future (long-term) market. The Network Trading Algorithm (NTA) calculates a set of prices for future timeslots and then auctions take place where users bid for bandwidth in each timeslot according to their ability to pay and the utility they would gain from acquiring available timeslots. The NTA makes adjustments to the prices in each timeslot according to demand. The process is iterated until an equilibrium is reached whereby the demand for bandwidth allocation never exceeds the available timeslots and the users have been allocated bandwidth according to their funds and utility. There is a spreading effect because timeslots further in the future will naturally tend to be in lower demand, and hence less expensive. This in turn makes them potentially more attractive to users who have a high utility in waiting to use less expensive bandwidth.

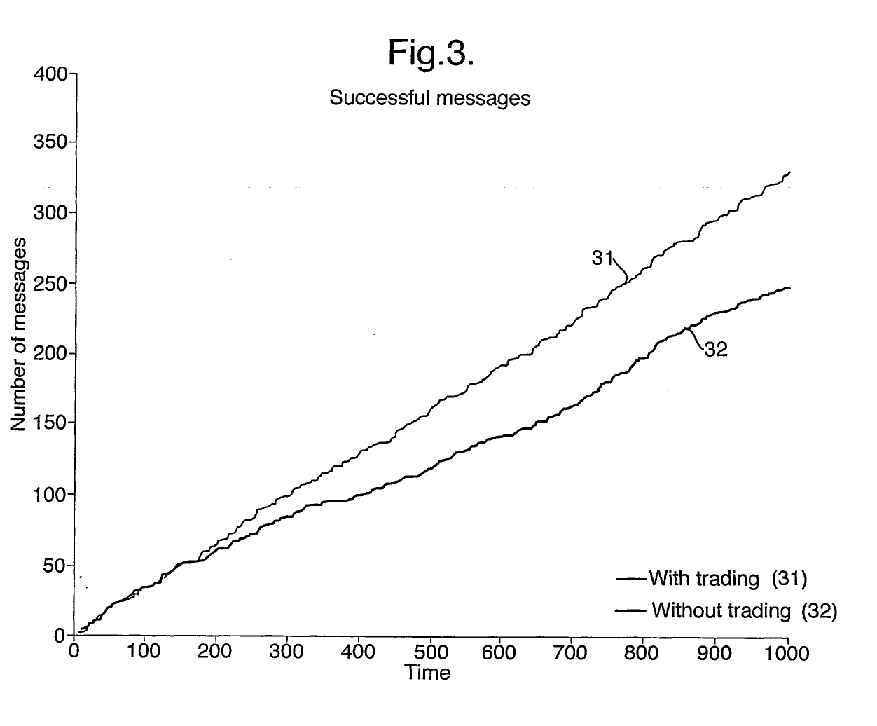

Referring now to FIG. 3, the proposed trading approach offers efficiency gains over non-trading solutions. The number of messages successfully transmitted over time using trading 31 exceeds that 32 achieved without trading.

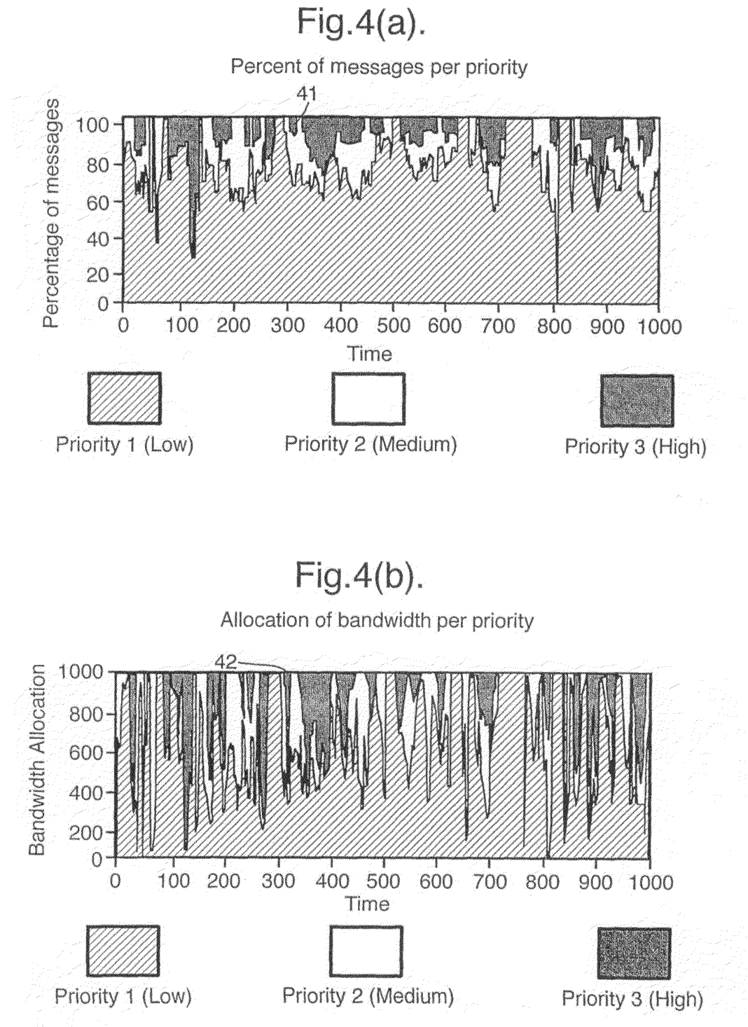

Referring now to FIGS. 4(a) and 4(b), use of the methods described above tends to allocate proportionately more resource to messages which have a high importance of allocation. So, for example, at time 325 whilst only a small proportion (approximately 10%) of high priority messages 41 are awaiting transmission, a proportionately much higher bandwidth allocation 42 is made constituting approximately 60% of the available bandwidth.

Note that the specific relationships illustrated differentiate resource allocation only in terms of priority but, as has been described above, other factors are also involved.

The congestion pricing mechanism described by Gibbens and Kelly can be combined with the trading mechanism described to provide a means of trading bandwidth without the need to know exactly how much bandwidth is available. Users can use the trading mechanism described above to buy Willingness-to-Pay (WtP) values rather than buy bandwidth directly. Users would be willing to spend more to obtain a higher WtP value because a higher WtP value would allow them a greater share of the bandwidth, as was shown in the previous work. The present method of allocating resources may of course also be combined with other known WtP methods.

The trading mechanism for such systems is essentially as described above but assumes an available resource (bandwidth) of 100(%). The allocated bandwidth that each user is assigned is then scaled such that the user assigned the highest amount of resource is given a WtP value of, for example, 10. Other users may be allocated resource proportionately. For example, if user A is allocated 80 units of bandwidth and user B 20 units of bandwidth, then user A may get a WtP value of 10 whilst user B will get a WtP value of 2.5, a quarter of A's allocation. Actual allocation of bandwidth may then proceed by known methods based on the respective allocated WtP values.

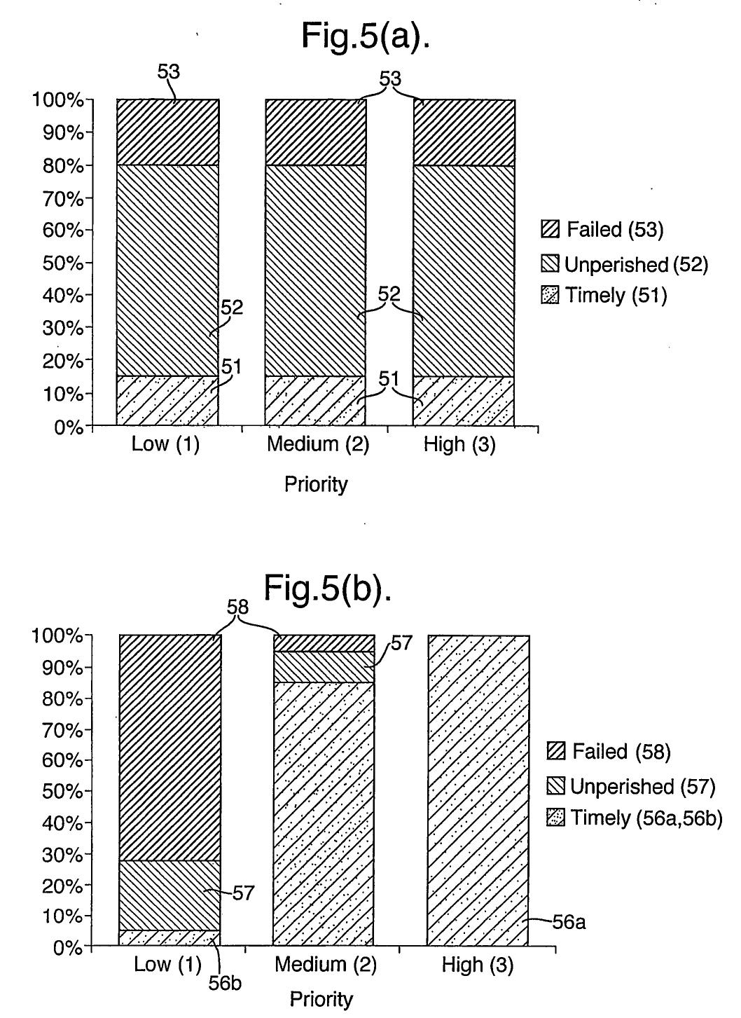

Referring now to FIG. 5(a), example transmission success rates for bandwidth allocation according to conventional TCP allocation methods may give rise to situations in which failure is evenly spread over all categories of traffic, regardless of the relative importance of resource allocation to different traffic. In the scenario illustrated the results for traffic in each of three priority categories is shown, with the respective proportions of timely (before timeliness threshold) 51, perishable (before perishability threshold) 52, and failed 53 traffic for low, medium, and high priority traffic are broadly uniform regardless of priority. Once again note that whilst for simplicity of representation data is shown plotted against priority, other component of importance as been described above have been applied.

Comparing that with the results illustrated in FIG. 5(b) relating to bandwidth allocation based on the present methods described above, noted that failed traffic 58 and traffic 57 delivered after its timeliness threshold predominantly occurs in low priority—and hence implicitly low importance of bandwidth allocation—traffic. Information which has a higher importance of timely transmission—and hence typically of higher value to the user—is given priority. In the example illustrated, all of the high priority traffic is delivered in a timely fashion 56a, whilst only a small proportion of low priority traffic is delivered in a timely fashion 56b.

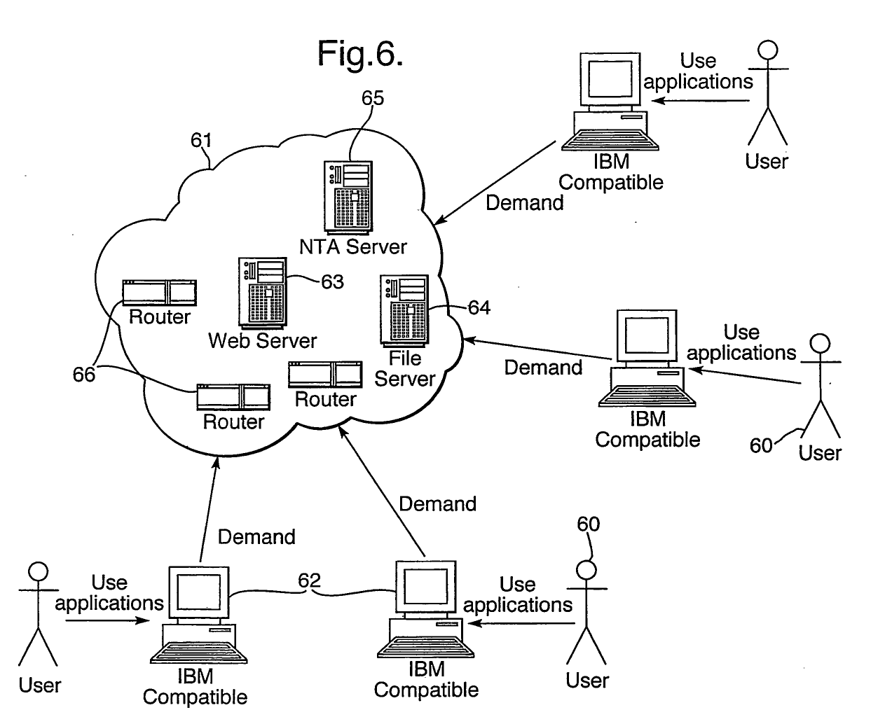

By way of a further example of the application of resource allocation, and referring now to FIG. 6, users 60 of a network place. a demand on the resource “cloud” 61 by using software application programs on computers 62 at the network periphery to obtain information from a web server 63 or send files to a file server 64. The cloud comprises a network of routers 66 and servers 63-5 and the assumption is that there is a uniform resource of bandwidth and a network trading agent (NTA) 65 to manage the bandwidth. There is no need for the bandwidth manager to know the precise detail of how the routers and servers are connected in order for it to manage the demand for bandwidth or server capacity. The network can be treated as a cloud of uniform resource and it is the function of the underlying protocols and the management systems to make this a reasonable assumption. In this instance the network bandwidth is considered to be the resource that is traded by balancing supply and demand. The capacity of the servers could equally be traded in that same way if that were considered a limiting factor in the network.

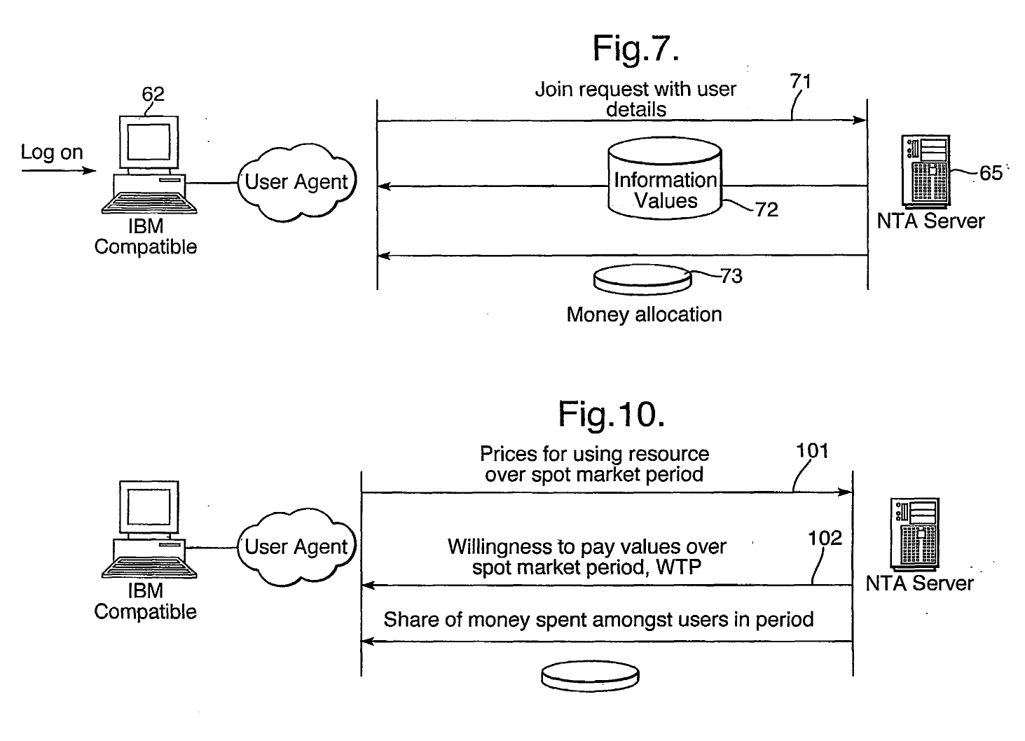

Referring now to FIG. 7, each user 60 joins the network by actioning the user agent 62 to connect to the NTA server 65. The user agent passes user account details 71 to the NTA server and the NTA server responds with details of specific information values 72 and an allocation of money 73 for that particular user. The money allocated to each user represents the proportion of the network resource that the user is allowed to use and hence reflects in one sense the relative importance of each user. The information values reflect the relative importance of information, relative timeliness and relative perishability of data to that user. The presence of the user agent software may be verified by the network management system requesting a response from the software to make sure the user has not disabled it. If the user agent software is not confirmed to be running for a particular user, that user's computer is preferably barred from the network and, for example, forced to contact a network administrator for reconnection.

An allocation of money to each user is made at the beginning of each reservation market trading period. This allocation can be thought of as the user's money for the period (which may be a month, week, day, minute, second, millisecond or any other time period appropriate to the application). The reservation market then operates as follows.

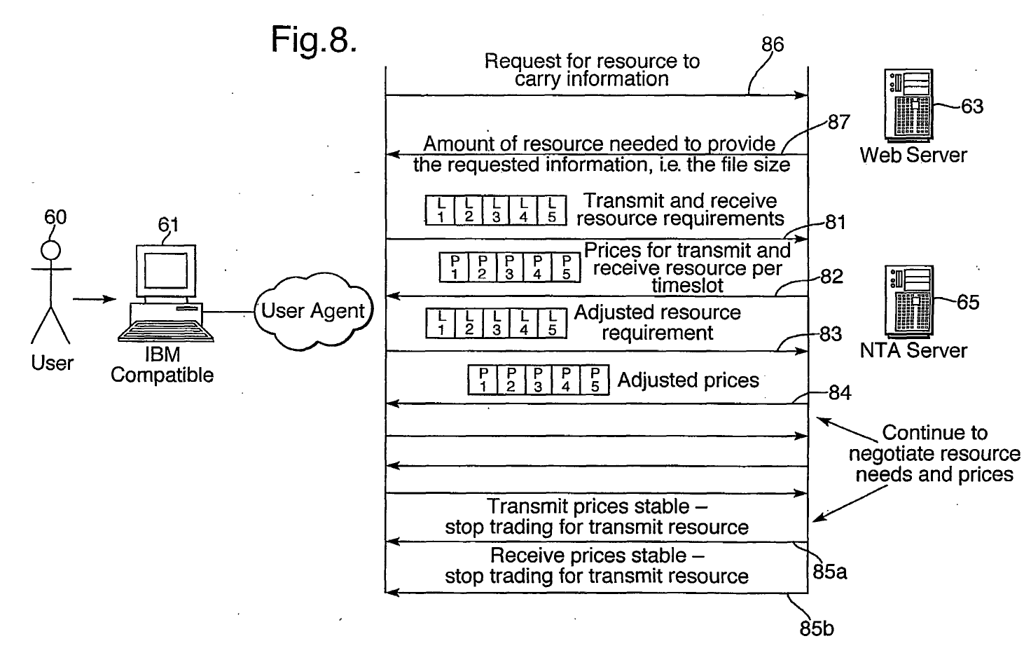

Referring now to FIG. 8, the user 61 identifies the information the user wants to transfer to the file server 64 and the information the user wants from the web server 65 over a pre-determined period of time (which could, for example, be the working day). This is done using a scheduler and flexibility over when the information is transferred is indicated by supplying alternative times and tolerance to variation. For example the user may specify that an hour either way for the file transfer doesn't matter.

The user agent 62 then calculates a time-slotted resource requirement vector 81 and declares it to the NTA. The NTA calculates a price vector 82 by adding up all prices generated from calculating the total demand on all resources involved, such as the bandwidth available in the network and the server load in facilitating the transfer of the information between the user and the server.

Once the user (or user agent) knows the price for resource per timeslot, it may choose to change its request and submit an adjusted time-slotted resource requirement vector 83 which in turn elicits an adjusted price vector 84 from the NTA.

For transmitted information (e.g. a file transfer from the user to the file server) the trading takes place between the user agent and the NTA as shown above. All transmit traffic would be traded in this way including transmit traffic to the web server in requesting a web pages.

For receive information (e.g. download of web information from a web server 63) trading takes place as described above for transmit traffic but in this case the user agent, the server storing the data for download, and the NTA are all involved in the trading. In this case a pre-cursor stage is added in which the user requests 86 from the web server an indication 87 of the size of the file to be downloaded. Once the user knows this information the process proceeds as above. This applies to all receive information, including an allowance for control data received during a file transfer.

Trading for transmit and receive information in practice may proceed concurrently. For example the resource vectors can be calculated at the same time for transmit and receive and sent to the NTA together. The NTA can then respond with both the transmit and receive price vectors at the same time. Trading for either transmit or receive resource could take longer than the other and so the indication to stop trading must indicate whether to stop trading for transmit 85a or receive 85b or both. Alternatively transmit and receive negotiations may proceed independently.

Additional resource is made available in the spot market so that users that did not take part in the reservation market can obtain some resource. So the NTA reduces prices in proportion to the increase in resource made available. Spot market trading takes place within each reservation market time slot. For example each hour is divided up into minute intervals and fine time trading takes place competing users that took part in the reservation market and those that just came along. The scheduler starts the demand for resource for the reservation users and the real user starts an application which leads to a demand for resource. Trading works exactly the same for the spot market as it does for the reservation market, but in fine time. Users are allocated resource on, for example, a minute by minute basis within the hourly timeslot. The prices for resource are based on the prices arrived at in the reservation market. Users that reserve may not use their allocation on a minute by minute basis and this leaves resource available for the users that didn't reserve. Also on a minute by minute bases, some data could be delayed without affecting the application that uses it, so the the data for users that didn't reserve could be interleaved with the data for the users that did reserve.

A different part of the information value file is used by the users that reserved which gives their information a higher importance and therefore higher priority. Although it is possible that spot market users could take some of their resource, it is unlikely due to this method of priority. Also, because reservation users agreed up front the resource they needed they are unlikely to have utility for more resource than allocated. So by holding back resource in the reservation market and then releasing it in the spot market, the spot market users tend to benefit.

So, users that are prepare to trade their requirements for resource up front take part in a reservation market which creates a schedule over coarse timeslots, say hourly intervals.

All users take part in the spot market where more resource is released “for sale” to benefit the spot market users. Trading takes place within fine time where data can be delayed without breaking the application that needs it and users that reserved but no longer have the same requirements can in fine time, release resource for the spot market users. By applying fine time trading user data can be interleaved to dynamically optimise the resource usage, sharing resource with those that reserved and that aren't prepared to wait or plan.

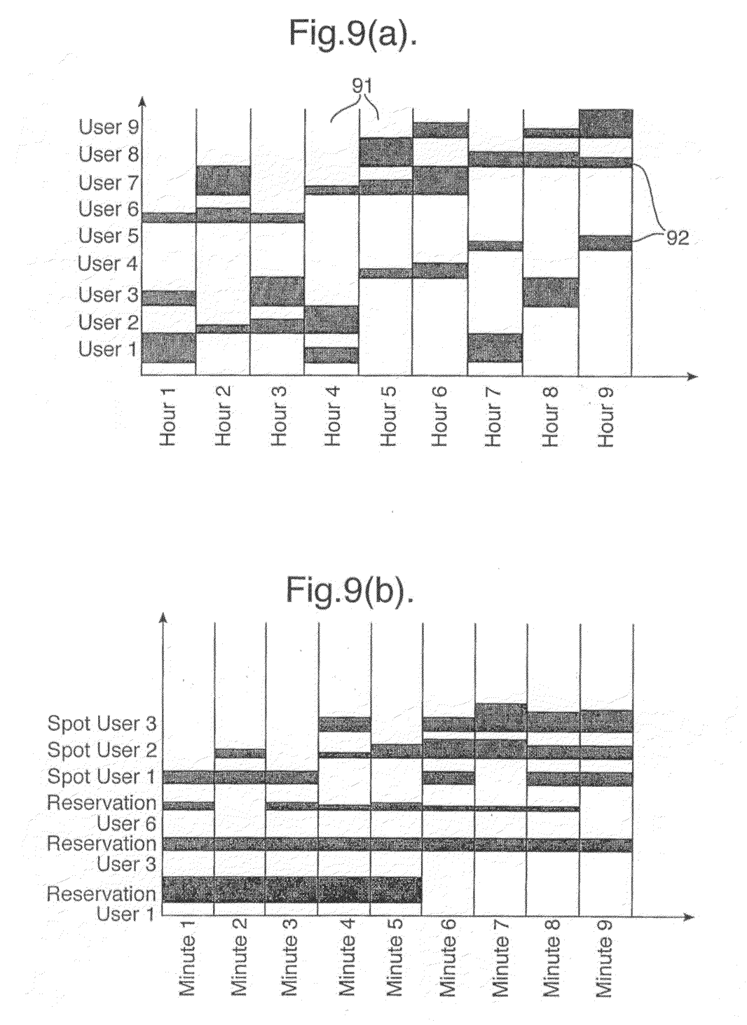

In one such system shown in FIG. 9(a), hourly slots 91 in a reservation market may be allocated to users as a result of trading for transmit traffic in the reservation market. The thickness of the allocation bars 92 is proportional to the amount of bandwidth allocated to each user and in each timeslot an equal total amount of bandwidth may be allocated. This total amount may be less than the total actually available, depending on overall demand. Although these reservations have been made and prices (a price for bandwidth and/or a price for server demand), have therefore been established for resources in each time slot, trading may nevertheless take place in a spot market before these resources are used.

Spot trading now takes place within the reservation periods (in this case of one hour each) using, for example, timeslots of 1 minute, and FIG. 9(b) illustrates the effects of spot trading within Hour 1 of the reservation market as shown in FIG. 9(a).

Within Hour 1 of the reservation market, Reservation User 1, Reservation User 3, and Reservation User 6 have made reservations. In minute 1 of the spot market each of these users actually uses their reserved allocation. Spot User 1 however can use some resource because additional resource remains to support the spot market. In minute 2, user 6 does not actually use the allocation and so spot user 2 successfully bids for it and uses it. Whenever the reservation users do not use their allocation or resource is specifically retained for spot market use, the spot market users share the available resource as best they can within the needs of the applications they are using. For example, if spot user 2 wanted to perform a file transfer, then this might well be successful since it may be interleaved into with the resource released by the reservation users. The spot users however also compete with each other to obtain resource within the needs of their applications and the relative worth of the information. So they bid minute by minute for resource, tolerating delays as necessary.

Using the price for resource generated by negotiations on the spot market, the user agent then pays 101 the NTA for a willingness to Pay (WtP) value 102 for each spot market interval (in this case for each minute of the spot market period). The user agent then transmits at the agreed rate in accordance with the spot market auction. As the network cloud 10 is unlikely in practice to be perfectly uniform, some routers may, for example, become congested. They can indicate this by issuing a congestion notification which is carried back to the user agent. The user agent collates the notifications and adjusts the transmission rate in inverse proportion to the WtP. If the network cloud was indeed a perfectly uniform resource then, by virtue of the reservation and spot market trading, there would be no congestion and no congestion notifications. Such a congestion control mechanism (for example that based Gibbens & Kelly's congestion control model) is a fine-tuning mechanism which operates within the spot market timeslot when transmission of data begins. Note that all resources within the cloud which become congested can respond with a congestion notification. This continues until the next spot market interval upon which a new spot market allocation is used to buy a new WtP value and transmission begins at a new rate, adjusted down in response to the congestion notifications.

Combining the above reservation market; spot market and congestion control elements gives rise to behaviours illustrated by the following example.

In the reservation market a proportion of the total available resource is not auctioned in order to leave to leave a minimum resource available for auction on the spot market
1. Registration of new user 71—a user agent is allocated as software that will trade on the users behalf.
2. Network trading agent NTA, passes information value file 72 to agent
3. NTA allocated 73 money and income to agent
4. If not prepared to reserve resource go to step 16, otherwise Information Exchange Requirement generated through scheduling interface
5. Resource vector 81 sent to NTA for transmitted information
6. NTA responds with a price vector 82
7. Resource request sent to information server for receive information 91
8. Server generates resource vector 92 to NTA by proxy
9. NTA responds to user agent with a price vector 82
10. Using the information value file, user updates transmit and receive resource vectors
11. Updated transmit and receive resource vectors 83 sent to NTA
12. NTA responds with transmit and receive price vectors 84
13. Iterate from step 10 until price vectors stabilise, or user abandons transaction.
14. When scheduled time for transmitting and receiving information go to 16.
15. New users joined or changes in availability of resources resource may cause the NTA to initiate a new auction (re-start at step 10), or amend allocation parameters mid-auction.

Once the long-time-period reservation auction is completed, allocation on the short-time-period spot market may commence. The spot auction largely mirrors the reservation market auction, but in this case all available resources are available for auction: none need be reserved for any other purpose.
16. A new or revised resource vector is sent to the NTA for transmitted information.
17. The NTA responds with a price vector derived from the reservation market auction.
18. A new or revised resource request is sent to the information server for receive information.
19. The server generates resource vector to NTA by proxy.
20. NTA responds to user agent with a price vector derived from the reservation market auction.
21. Using the information value file, the user updates transmit and receive resource vectors. Users who have already reserved resource are given priority over users requesting unreserved resource.
22. Updated transmit and receive resource vectors sent to NTA.
23. NTA responds with transmit and receive price vectors.
24. Iterate from step 21 until price vectors stabilise, or user abandons transaction. When both reservation auction and spot auction have been completed resource utilisation proceeds. It is at this stage that congestion price control acts to correct any over-allocation of resource.
25. According to the agreed auction price for resource, the user agent buys WtP value from NTA and/or QoS parameters reserving or prioritising resource usage.
26. According to the agreed auction price for resource, the information server agent buys WtP value from NTA and/or QoS parameters reserving or prioritising resource usage
27. User and information server transfer information using a suitable congestion control method (for example that of Gibbens & Kelly), adjusting rate according to congestion charges received and WtP value bought.
28. If resource becomes so congested that it is no longer possible to continue, go to step 4.

Whilst this method of resource allocation has been described in terms of a two-stage allocation with reservation market and spot market, it will be apparent that resources could be allocated entirely using a single-stage model (in effect a spot market model only, though with timescales of any duration as appropriate to the application) and similarly the method may comprise three or more levels of allocation of ever finer time intervals.

Although described in detail above in terms of resource allocation in a computer or communications network, the underlying methods clearly have a much wider application in a wide range of fields. Many, though by no means all, of which also relate to computer and communications systems—including, but not limited to, the following:
Congestion management—Charging may be applied to network usage by counting the instances where congestion is caused: where congestion is high the computers causing the congestion reduce their network usage by virtue of the resource allocation method. This saves money overall by reducing the occurrences of network equipment failure and the need to reset or review the ability of the network to deal with high usage.
Disaster recovery—During times of over-demand on a network, the usage may be controlled so that the network degrades in a controlled way rather than suddenly, and consequently failing without warning.
Core service guarantees—Services of high importance to a business may be maintained even when others fail due to over-utilisation of network and systems resources. Both core users and core services can be protected from collapse due to over-emand and save the loss of business critical service.
Server demand management—In a cabled network which provides a web hosting service, for example, the servers can be protected from demand peaks leading to server collapse. Server time is the allocated resource. In this situation the servers are the resources that need protecting from over demand as the network can provide much more bandwidth than needed. Service downtime and the cost of restoring the service is avoided.
Application layer rate adaptation and admission control—The present resource trading solution is designed to work closely with computer applications software and, by doing so, addresses a problem frequently encountered where the network has become slow through demand, but the application software carries on trying to use the network. This leads to service and computer hang-up and can lead to the need to re-install applications or rebuild the computer software due to corruption. By using the present methods to allocate resources, the loss of application software data may also be avoided.
Resource allocation and server sharing—User demand on servers can be. managed by sharing demand. The trading mechanism described above makes it possible to allocate demand taking into consideration how busy servers are in providing services to customers, or to a business.
Spectrum management—Radio spectrum is a valuable and limited resource which can be dynamically shared. Allocation may be controlled using the trading mechanism. By doing this optimum use can be made of the spectrum available in providing services to applications, network operators, or end-users (e.g. mobile phone users)
Information management—A simple method of associating a value with items of information is applied. Application of the allocation methods described above leads to prioritisation of information according to its value during times of high network demand. This ensures that business-critical or high revenue-generating information is transferred when a network is congested and none essential information is delayed.
User demand management—Just as information may be prioritised during times of high network demand, so may certain users. This technique makes it possible to balance the user's importance to the business with the value of the information to the business—or to the user—and hence decide how much resource to allocate.
End-to-end service management—In order to apply the resource trading mechanism using the present methods there is no need to understand or know the internal details of how the network works since the solution works on a service and user basis, end-to-end across the network cloud. This therefore helps to provide a means of providing an agreed quality of service to users across a network that provides shared bandwidth and service systems, irrespective of how these resources are provided.
Dynamic bandwidth allocation—Bandwidth can be allocated and managed on-the-fly with reduced configuration costs and with no need for expert intervention.
Dynamic service charging—Services, information, and bandwidth usage can be charged for according to usage. Costs and tariffs can be included in addition to charges based on the demand for service, information and bandwidth.
Channel management on satellite links—The resource trading mechanism can be applied to trading of channels in a satellite link, either by charging real money or as a way to make best use of the channel available, including sharing channels between users and services.
Fallback bandwidth allocation sensitive to service cost and congestion—To save costs to businesses, this solution may be used to take into account the real cost to the business of using alternative links provided by different service providers. For example, if a primary internet link becomes congested and there is an alternative link of limited capacity, the cost of using the alternative link as a fallback can be taken into account and its use limited accordingly until the primary link becomes less congested.
Increased utilisation efficiency in a bandwidth limited environment—In networks where radio links are the main method of achieving communications (e.g. wireless LAN's), resource trading facilitates optimal usage of the limited bandwidth available.
Optimisation of information flows according to importance of information to the business processes—Information transferred can be controlled dynamically according to business need, ensuring that less important business related activities supported by the business intranet, of less revenue generating services, do not dominate the core needs of the business. Profit or business efficiency saving overhead costs can be maximised in this way.
Performance Indicators and resource usage and user demand accounting for capacity planning—Intrinsic to the way the mechanism works are performance indicators that can be used to track the way the network is used and assess the need to provide more network resources.
Management of traffic in legacy networks delaying the need to upgrade—As there is no need for direct interaction with the underlying network, legacy networks, based on repeaters hubs for example, can be managed to provide quality of service when no ability do this exists without the trading solution. The cost of upgrading legacy networks can be postponed until the indicators provided by the mechanism indicate it is advisable to do so to provide the needed capacity. The cost of downtime can also be reduced whilst an upgrade program is planned.
Charging and service management in 3G and other wireless telecommunications systems—As well as providing a way of making the most of limited bandwidth and service resource, the trading mechanism supports a direct way of charging users for service and in doing this, the behaviour of the users may be modified according to the level of service for which they are prepared to pay.
Managing the utilisation of chargeable services, such as an Internet service provider (ISP) link to a business intranet—Saving universities money for example is possible by dynamically managing the bandwidth they use on their internal and external links provided by an ISP. Where an ISP charges per packet for Internet use, this mechanism provides a way of managing the charges incurred. The same solution also applies to a business intranet that makes use of an ISP link to the internet.
Utilisation of bandwidth that would other wise be wasted as reserved but not used—One of the features of the trading mechanism is that all bandwidth is made available in a managed way, so that once all of the reserved capacity is used, any piece meal bandwidth left over can be utilised on an add hoc basis.
Optimisation of point to point trunks—Where a number of networks are interconnected by relatively low bandwidth links this solution can be used to managed the inter-network traffic to avoid inter-link saturation and costly down-time.
Route based information flow management—Information can be managed according to the route taken across the network and the mechanism can be adapted to provide route-based traffic management.
End to end information flow management in a composite network of networks—Within a network of networks resource trading can be extended to take into consideration the demand within each part of the network and then manage information flows that cross the entire composite network.
The security of dependable distributed dynamic systems—As all users must register with the NTA and pay to use network resources, access to the resources is controlled and logged. Access security is a consequence of the trading mechanism.

Other applications in which resources need to be managed over relatively short and/or long time scales are also candidates for application of the methods described above. Such areas include, but are not limited to:
Travel, holiday, and entertainment venue booking systems (e.g. allocation of people to train, aircraft seats, hotel rooms, theatre seats, etc.)
Road congestion management (e.g. setting of road toll levels)
Telephone charging according to user demand
Video on demand systems according to user demand
Healthcare patient management according to urgency and demand (for example in clinics and hospitals)
Utility supply and/or pricing (e.g. demand driven supply and/or pricing of gas, water, electricity, etc.) management
Stock distribution systems
Call centre management systems

Other systems which are resource constrained and designed to deliver a service or product to a user or customer could be managed by this solution. This solution is therefore applicable to management of any system, which has a constrained resource that is in demand to supply a service, product, or facility to a number of users or customers, or other resource occupiers/consumers.

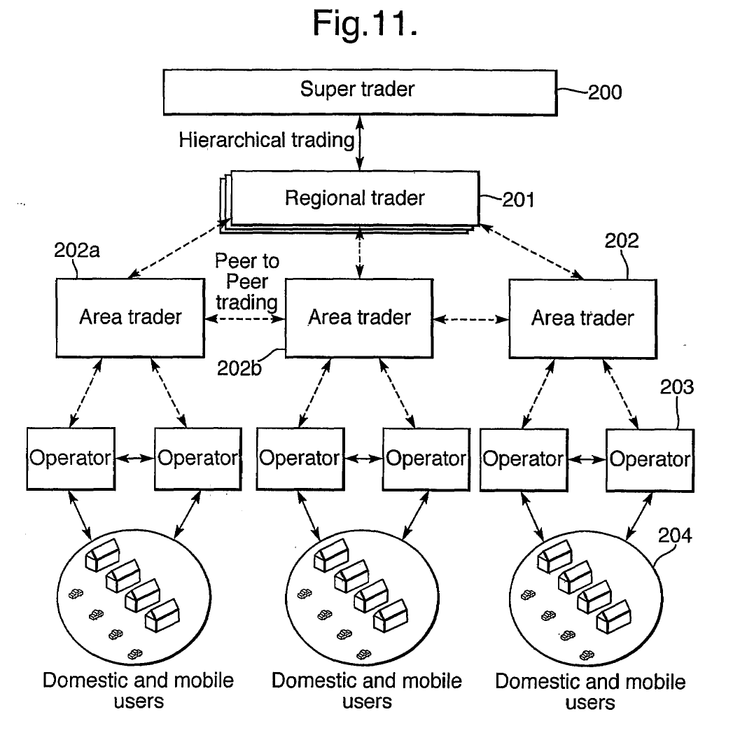

Referring now to FIG. 11, trading systems may involve both hierarchical and peer-to-peer trading and trading based on geographical distribution of users and traders. In the example illustrated trading successive levels 200-203 of resource allocators (and hence traders). A super trader 200 (for example a national radio spectrum regulator) may allocate resource to multiple regional traders 201 who in turn sub-allocate their allocated resource to area traders 202. Resource demand at each level influences the price which each trader is willing to pay for resource at any given time.

In some cases, traders 202a, 202b at the same level may trade amongst themselves in what is referred to as peer-to-peer trading. This allows a trader, having been previously allocated resource which is currently or temporarily not required by that trader's own user community, to re-sell that resource (optionally on a temporary basis) to a peer trader who's demand exceeds the resource previously allocated to it. In such hierarchical and peer-to-peer networks of traders, resource trading can be applied at least in the following ways as summarised in the table below, along with example applications.

In this context the present inventors have observed that a resource trading algorithm, such as that described above, can be applied to determine a price for a resource by running the algorithm but without actually allocating resource to the users. In this way the method can be used to determine a bid price which traders can then use when bidding for their own resource allocation from a hierarchically superior (or peer or any other) resource allocator. This opens up a whole range of different ways resource trading can be scaled and which are described in more below. Examples of areas of application are shown in the following Table:

| Implementation | Example application |
|---|---|
| Local trading within an allocated resource | Network bandwidth management in a |
| | wireless LAN |
| Trading across alternative resources | A wireless LAN where each user can join |
| | one of many allocations of bandwidth |
| | and resource trading domains |
| Peer-to-peer across many resources to | Allocation of bandwidth across a network |
| establish a path to a service | of networks. A price has to be paid for |
| | transit traffic |
| Peer-to-peer to trade for a single | Frequency assignment across a |
| allocation of resource | geographical region, area by area |
| Peer-to-peer to trade for a multiple | Spectrum assignment across |
| allocation of resource | geographical regions. Regions are |
| | allocated a part of the spectrum which |
| | can in turn be traded within a region |
| Hierarchically to trade for an allocation of | To share network bandwidth between |
| shared resource | different communities of users in a |
| | shared network, or on a shared single |
| | link. For example, different departments |
| | may be allocated different amounts of |
| | shared bandwidth |
| Hierarchically to trade across multiple | To allocate a frequency to an operator |
| resources for an allocation of single resource | from an allocation of spectrum in an area |
| Hierarchically to trade across multiple | To trade for spectrum within a region's |
| resources for an allocation of multiple | allocation of spectrum, to allocate |
| resources | spectrum to an area |

In each of these cases the resource trading algorithm can be implemented on a central trader which trades with local traders, or it could be implemented by trading between traders. These implementations can be combined as needed to trade resource allocations and resources as required. So hierarchical trading can be combined with peer-to-peer trading etc.

Local trading within an allocated resource utilises the basic resource trading algorithm as described in detail. This is the most basic way of applying the algorithm for managing demand in a single resource such as network bandwidth.

Trading across alternative resources involves one further step to extend the use of the algorithm where there is more than one resource a user could join and use. For example, there could be a number of alternative networks which a user could choose to join. This is a simple extension of the way the algorithm is used. When a user wants to use resource, then the user requests the current price for resource for each alternative resource available from a trader. The trader then responds with the current price associated with each resource and the user then joins the auction for the resource that has the lowest current price. The trading algorithm is then operated in the normal way.

There can be more than one trader offering to sell resource, or a number of resources, for a given price. Consequently a user can opt to choose the least expensive source of resource between traders, as well as across available resources offered by a single trader.

A user could also choose to leave an auction if due, for example, to price inflation they find their messages continually perish. Leaving users may move to a cheaper auction as an alternative to get better service

In the context of peer-to-peer trading across many resources to establish a path to a service, the algorithm can be applied to bid for resource along an end-to-end path. For example, if a users needs to access a remote server outside the user's local network, then the user will need bandwidth from the local network along with bandwidth from all the networks along the way to the remote server. This means that networks can have a need to support transit traffic (i.e. traffic which their own local users do not source or sink) but does require bandwidth. Each network would then apply the algorithm so as to determine a price for the request for transit bandwidth and (optionally) apply a tariff as the traffic is not locally owned. Therefore a user which bids to buy bandwidth across multiple networks will have to pay for local bandwidth within his local network, and also add the charges for bandwidth across all the other networks involved.

So the algorithm may be modified as follows. A user would trade with its local trader to gain a quote for local resource. The user would also have to obtain a quote for all other resources required along the peer-to-peer path. A tariff factor may be applied by each remote trader to the price they quote because they do not “own” this user's demand. The users would then apply the algorithm by adding all the quotes, to decide how much resource to bid for. So the total price, P, for resource used by the user in the trading algorithm would be:

$$P = {P}_{0} + {\sum }_{i = 1}^{n} ( {T}_{i} \times {P}_{i} ) \qquad ( 4 )$$

where P₀ is the price quoted for local resource, Tᵢ is the tariff applied by resource i for transit demand and Pₙ is the price quoted by resource i. The user's trader could construct this price on the user's behalf, rather than have the user trade directly with all the traders along the proposed path.

Just as the resource required by a user could be bandwidth, some of the resource could be server capacity, for example. So using the resource trading algorithm, all resources involved in providing a service to a user can be traded in this way, peer-to-peer, trader to trader, end to end.

In peer-to-peer trading for a single allocation of resource, a trader trades for an allocation of resource by trading for resource with some or all of the traders that surround it. In this way, traders may be allocated resource area by area. This may be achieved as follows.

The resources available to be allocated are ordered by size and therefore value to a trader. These resources are marked as unavailable in a local table if another trader claims them as a result of an auction. Provided the first resource is available, the trader takes the size of the resource and uses this to run the algorithm without allocating resource to it users, and by doing so determines a price for that resource. The trader then bids with all of the surrounding traders using this price. If the trader bids the highest price then it claims the resource and begins to trade it amongst its users. Otherwise it marks the resource as unavailable within its local table and repeats the process for the next resource in the list. This is repeated until the trader wins an auction and claims a resource, or finds that there is no unallocated resource left to bid for. In the latter case the trader would have to wait for a future bidding round.

The relative amount of money allocated to each trader, which in turn is shared amongst its users, determines how successful each trader will be in bidding for resource because it affects the price bid. This can be used to control this process to ensure resources are allocated to traders as required. For example those traders that did not win a resource allocation may be paid compensation so that in a future bidding round they are more likely to win an allocation. The amount of money allocated to each trader may be related to how much real money the traders have paid for a license to bid for resource.

Another surrounding trader can call an auction at any time with the trader to bid for any resource in the list. The trader responds by bidding against the other trader if it has not already claimed a resource to use.

In peer-to-peer trading for a multiple allocation of resource the trader can bid for more than one resource. Once again the resources available may be ordered (e.g. by size) in a local table and the trader makes a bid for the first available resource, using the algorithm to determine the price for the resource according to the resource size. All traders which lose the auction mark the resource as unavailable in their local table. Once a trader has claimed a resource by winning a bid, that trader may continue to bid for more resource in the same way. However, in further bids, that trader adds all the resource previously won to the size of the resource it is bidding for when determining its price. Therefore the bid price will drop as the trader wins more and more resource. This means that as the trader's requirement for resource is satisfied it will be less determined to win further resource when bidding with other traders. In this way, some traders may win one resource to trade and some traders may win many. Some traders could win none at all and would have to wait for a future bidding round.

Once again, the relative amount of money allocated to each trader determines how successful they will be in bidding for resource because it affects the price bid. This can be used to control this process to ensure resources are allocated to traders as required, particularly to those traders that lost out altogether in previous bidding rounds. The amount of money allocated to each trader may also be related to how much real money the traders have paid for a license to bid for resource.

Any other surrounding trader can action an auction for any available resource at any time. As previously described, the availability of resource is indicated in a table and after each auction all traders that lose in the bidding mark the resource bid for as unavailable in each of their local tables.

In hierarchical trading for an allocation of shared resource the resource trading algorithm determines a price for resource as previous explained. This can be used to determine an allocation of part of a resource shared with another trader. For example, there could be two departments sharing the same campus network LAN, whereby each department has a different amount of money allocated to its users, different user needs and therefore different demand for resource. Each department could therefore share a proportion of the bandwidth available and trade that share amongst its users. So a third of the bandwidth could be allocated to department A to trade across its users. The remaining bandwidth would then be traded within department B.

The share of resource may be allocated as follows. Each trader would allocate all of the resource available to the algorithm and trade amongst its users to arrive at a price for resource if all the resource where available. This price reflects demand for resource within that trader's market. These users would not be allowed to buy resource at this stage as the algorithm is being used to determine a price only, without selling resource. The resource allocated to each trader would then be divided up according to these prices. So if there were two traders, a and b, and Pₐ is the price for resource determined for trader a, and P_{b} is for b, then the resource allocation for a, denoted Rₐ, may be defined by:

$${R}_{a} = \frac{{P}_{a}}{( {P}_{a} + {P}_{b} )} \times {R}_{t} \qquad ( 5 )$$

### In which Rₜ is the total resource.

Once the share of resource has been allocated, resource trading takes place as normal, using these shares to allocated resource to the users within each trading domain.

As for peer-to-peer, the relative amount of money allocated to each trader determines how successful they will be in bidding for a share of resource because it affects the price bid, and this can be used to control this process to ensure resources are allocated to traders as required. The amount of money allocated to each trader could be related to how much real money the traders have paid for a license to bid for resource.

In hierarchical trading across multiple resources for an allocation of single resource a number of resources of different sizes are available for allocation to traders. The resources are ordered according to size, the largest resource being considered the most valuable and the smallest the least valuable. All traders bid for each resource, starting with the largest resource and working towards the smallest. In bidding for the first resource each trader runs the algorithm using the size of the resource (i.e. the amount of bandwidth) to determine the price that the trader could sell resource to its users for. This price, as before, represents the demand for resource within the traders' domain. This price is then simply used as the bid to claim the resource. The trader that bids the highest price, and therefore has the greatest need to win the bidding, is allocated the resource. The winner can then use the resource to trade amongst its users using the algorithm and drops out of this auction process. The next resource available is then auctioned across the remaining traders in the same way. This process continues until all the available resource has been allocated to traders to trade, or all traders have the resource they need to trade. Traders which failed to win a resource allocation would have to wait for the next bidding round.

Once again, the relative amount of money allocated to each trader determines how successful they will be in bidding for resource because it affects the price bid, and this can be used to control this process to ensure resources are allocated to traders as required, and to compensate traders that failed to win resource. The amount of money allocated to each trader could be related to how much real money the traders have paid for a license to bid for resource.

In hierarchical trading across multiple resources for an allocation of multiple resources, the aim is to allocate resource to traders, such that each trader can claim more that one allocation of resource, and then share these allocations across its users, by running more than one resource trading algorithm. This done by ordering the resources to be allocated as previously described. Traders bid for the first resource, as described above, using the algorithm to determine the price for resource each trader will bid. The resource is then allocated to the highest bidder. The highest bidder then continues to bid for more allocations of resource by joining the bidding for the next resource in order. This time though, the bidder that won the first allocation determines its price for resource, using the algorithm, by adding the size of the previously won resource to that of the resource currently being auctioned. This means that the traders demand for more resource is likely to be less and therefore the price bid is likely to be less, as the trader already has a resource allocation. So, using the algorithm and summing resource already won with the resource being bid for, bid prices are determined for traders that already have resource. The trader that bids the highest is then allocated the resource in this auction, which may or may not be a trader that already has resource. All traders then join the next auction in the sequence and the process continues until all resources have been allocated. Some traders may win one resource to trade and some traders may win many and some none at all.

Once again the success of a trader in bidding will be determined by how much money is allocated to the trader relative to the other traders.

Any range or device value given herein may be extended or altered without losing the effect sought, as will be apparent to the skilled person for an understanding of the teachings herein.

1. An automated method of allocating a plurality of resource occupiers to resources, the method comprising:
associating with each resource occupier a timeliness threshold;
for each resource occupier calculating a measure of urgency of allocation responsive to the timeliness threshold and a measure of the size of the resource occupier;
allocating the resources responsive to the respective measures of urgency of allocation.

2. A method according to claim 1 comprising:
associating with each resource occupier a perishability threshold;
calculating the measure of urgency of allocation responsive to the timeliness threshold, the perishability threshold, and the measure of the size of the resource occupier.

3. A method according to claim 2 in which no resource is allocated to a resource occupier whose perishability threshold lies in the past.

4. A method according to claim 1 in which urgency of allocation is a rising convex function up to the timeliness threshold.

5. A method according to claim 1 in which urgency of allocation is a falling convex function between the timeliness threshold and the perishability threshold.

6. A method according to claim 1 in which urgency of allocation is zero after the perishability threshold.

7. A method according to any preceding claim 1 in which the measure of urgency, A, is calculated as:
$$A = \{ \begin{matrix}{P}^{3} arc tan ( \frac{{l}_{t}}{\vert {t}_{j} - t \vert} ) \frac{{( 1 + t )}^{2}}{{( 1 + {t}_{j}^{2} )}^{2}} … 0 \leq t \leq {t}_{j} \\ {P}^{3} arc tan ( \frac{{l}_{t}}{\vert {t}_{j} - t \vert} ) \frac{{( 1 + {t}_{j} )}^{2}}{{( 1 + {t}_{j}^{2} )}^{2}} ( \frac{{( t - {p}_{j} )}^{n}}{{( {t}_{j} - {p}_{j} )}^{n}} ) … {t}_{j} < t \leq {p}_{j} \\ 0 … t > {p}_{j} .\end{matrix}$$
in which:
P is the priority
lₜ is the amount of resource required
tⱼ is the timeliness threshold
pⱼ is the persihability threshold
t is the current time.

8. A method according to claim 1 in which the resources comprise transmission bandwidth.

9. A method according to claim 1 in which the resources comprise radio spectrum bandwidth.

10. A method according to claim 1 in which the resources comprise entities for occupation by people and the resource occupiers comprise people.

11. A method according to claim 1 in which the resource occupiers comprise vehicles.

12. A method according to claim 1 in which the resource comprises Willingness to Pay values.

13. A system for allocating a plurality of resource occupiers to resources, the system comprising:
means for associating with each resource occupier a timeliness threshold;
means for calculating, for each resource occupier, a measure of urgency of allocation responsive to the timeliness threshold and a measure of the size of the resource occupier;
means for allocating the resources responsive to the respective measures of urgency of allocation.

14. A computer program located on a computer readable medium for allocating a plurality of resource occupiers to resources, the program comprising code portions arranged for:
associating with each resource occupier a timeliness threshold;
for each resource occupier calculating a measure of urgency of allocation responsive to the timeliness threshold and a measure of the size of the resource occupier;
allocating the resources responsive to the respective measures of urgency of allocation.

15. A An automated method of allocating radio spectrum between a first set of prospective spectrum users, the method comprising the steps of:
conducting an first automated auction between the members of the first set in which the bid price offered by a first member of the first set is determined responsive to a second automated auction held between members of a second set of prospective spectrum users associated with the first member of the first set;
allocating spectrum to members of the first set responsive to the first automated auction.

16. A method according to claim 15 in which the first auction and second auction are conducted in real time.

17. A method according to claim 15 in which resources are allocated to members of the second set according to the method of claim 1.

18. An automated system for allocating radio spectrum between a first set of prospective spectrum users, the system comprising:
means for conducting an first automated auction between the members of the first set in which the bid price offered by a first member of the first set is determined responsive to a second automated auction held between members of a second set of prospective spectrum users associated with the first member of the first set;
means for allocating spectrum to members of the first set responsive to the first automated auction.

19. A computer program located on a computer readable medium for allocating radio spectrum between a first set of prospective spectrum users, the program comprising code portions arranged for:
conducting an first automated auction between the members of the first set in which the bid price offered by a first member of the first set is determined responsive to a second automated auction held between members of a second set of prospective spectrum users associated with the first member of the first set;
allocating spectrum to members of the first set responsive to the first automated auction.
